(19) United States
(12) Patent Application Publication
(10) Pub. No.: US 2024/0270092 A1
(43) Pub. Date: Aug. 15, 2024

(54) VEHICLE CONTROL DEVICE

(71) Applicant: TOYOTA JIDOSHA KABUSHIKI KAISHA, Toyota-shi (JP)

(72) Inventors: Toshiya HASHIMOTO, Miyoshi-shi (JP); Masato MAEMURA, Nisshin-shi (JP); Shogo TSUGE, Fuji-shi (JP); Ryosuke IKEMURA, Susono-shi (JP)

(73) Assignee: TOYOTA JIDOSHA KABUSHIKI KAISHA, Toyota-shi (JP)

(21) Appl. No.: 18/405,079

(22) Filed: Jan. 5, 2024

(30) Foreign Application Priority Data
Feb. 14, 2023 (JP) 2023-021033

(51) Int. Cl. B60L 53/122; H02J 50/10; H02J 50/80; H02J 50/90

(52) U.S. Cl. CPC B60L 53/122; H02J 50/10; H02J 50/80; H02J 50/90; H02J 50/60

(57) ABSTRACT

A vehicle control device controls a vehicle having a secondary coil that receives non-contactly transmitted power from a primary coil installed on a road. Further, the vehicle control device switches Fine Positioning from an on state to an off state when determining that the vehicle is traveling outside a D-WPT section or the vehicle is traveling outside a D-WPT lane on a basis of position information of the vehicle.

### CROSS-REFERENCE TO RELATED APPLICATION (S)

The present application claims priority to and incorporates by reference the entire contents of Japanese Patent Application No. 2023-21033 filed in Japan on Feb. 14, 2023.

### BACKGROUND

The present disclosure relates to a vehicle control device.

Japanese Laid-open Patent Publication No. 2015-228047 discloses a wireless power transfer system for transmitting power in a non-contact manner to a vehicle in operation, the vehicle and the server in operation are communicatively connected to provide travel support information from the server to the vehicle in operation.

Running support information is information for improving the charging efficiency of the power transmitted from the supply device of the traveling lane, including the traveling position and vehicle speed of the vehicle to satisfy the condition that the charging efficiency is equal to or greater than a predetermined value.

### SUMMARY

There is a need to provide a vehicle controller that is capable of determining whether a running vehicle is in a situation where alignment of a primary coil on the ground side and a secondary coil on the vehicle side is required or not.

According to an embodiment, a vehicle control device controls a vehicle having a secondary coil that receives non-contactly transmitted power from a primary coil installed on a road. Further, the vehicle control device switches Fine Positioning from an on state to an off state when determining that the vehicle is traveling outside a D-WPT section or the vehicle is traveling outside a D-WPT lane on a basis of position information of the vehicle.

### BRIEF DESCRIPTION OF THE DRAWINGS

FIG. 1 is a schematic diagram illustrating a wireless power transfer system in the embodiment;

FIG. 2 is a diagram illustrating the overall configuration of a wireless power transfer system;

FIG. 3 is a schematic diagram for explaining wide-area wireless communication in a wireless power transfer system;

FIG. 4 is a block diagram for explaining a functional configuration of a power transmission ECU;

FIG. 5 is a block diagram for explaining a functional configuration of a vehicle ECU;

FIG. 6 is a diagram for explaining a power transmission process;

FIG. 7 is a sequence diagram illustrating a case in which communication using wide-area wireless communication is performed between the vehicle and the supply device;

FIG. 8 is a sequence diagram illustrating an operation after the power supply during running from the supply device to the vehicle is completed; and

FIG. 9 is a flowchart illustrating the control of the detailed alignment.

### DETAILED DESCRIPTION

In the related art, when the running vehicle receives power from the primary coil on the ground in a non-contact position, the primary coil on the ground and the secondary coil on the vehicle are aligned to increase the transmission efficiency of the power. In this case, it is desired to accurately align the position of the primary coil and the secondary coil. However, since the running vehicle is not always in a situation where alignment of the primary coil and the secondary coil is required, power is wasted when sensors or beacons for alignment are constantly activated.

Hereinafter, a vehicle control apparatus according to an embodiment of the present disclosure will be specifically described. Note that the present disclosure is not limited to the embodiments described below.

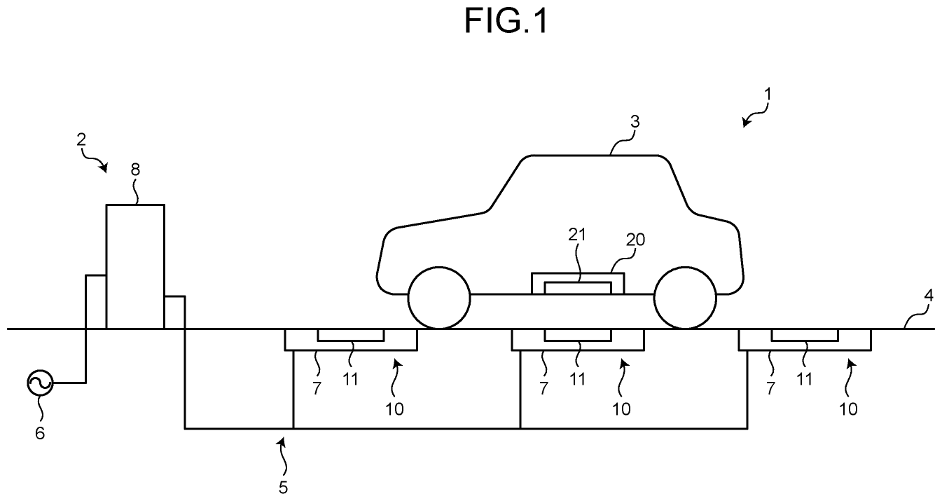

FIG. 1 is a schematic diagram illustrating a wireless power transfer system in the embodiment. The wireless power transfer system (Wireless Power Transfer System) 1 includes a supply facility 2 and a vehicle 3. The supply facility 2 is a facility for supplying power to the vehicle 3 in the running non-contact. The vehicle 3 is an electric vehicle capable of charging power supplied from an external power source, for example, an electric vehicle (BEV) or a plug-in hybrid vehicle (PHEV) or the like.

The wireless power transfer system 1 performs wireless power transmission by magnetic field resonance coupling (magnetic field resonance) from the supply facility 2 to the vehicle 3. The wireless power transfer system 1 transmits power from the supply facility 2 in a non-contact manner to the vehicle 3 traveling on the road 4. That is, the wireless power transfer system 1 is for transmitting power by the magnetic field resonance system, in which to realize the running power supply to the vehicle 3 using the magnetic field resonance coupling (magnetic field resonance). The wireless power transfer system 1 can be expressed as a dynamic wireless power transmission (D-WPT) system or a magnetic field dynamic wireless power transmission (MF-D-WPT) system.

The supply facility 2 includes a supply device 5, an AC power source 6 for supplying power to the supply device 5. The supply device 5 transmits the power supplied from the AC power source 6 to the vehicle 3 in a non-contact manner. The AC power source 6 is, for example, a commercial power supply. The supply device 5 includes a power transmission device 10 having a primary coil 11.

The supply device 5 includes a segment 7 including a primary coil 11 and a management device 8 which manages the segment 7. The segment 7 is embedded within the lane of road 4. The management device 8 is installed beside the road 4. The segment 7 is electrically connected to the management device 8. The management device 8 is electrically connected to the AC power supply 6 and supplies the power of the AC power supply 6 to the segment 7. The segment 7 is electrically connected to the AC power source 6 via the management device 8. This segment 7 can be arranged in plural along the lane of the road 4. For example, the supply device 5, as shown in FIG. 1, includes three segments 7 installed side by side along the lane in the road 4, one management device 8 three segments 7 are connected. The segment 7 has a function of transmitting power from the supply device 5 to the vehicle 3 in a non-contact manner. The management device 8 has the function of controlling the wireless power transmission in the segment 7.

The vehicle 3 includes a power reception device 20 having a secondary coil 21. The power reception device 20 is provided at the bottom of the vehicle body of the vehicle 3. When the vehicle 3 travels on the road 4 where the primary coil 11 is installed, the primary coil 11 on the ground side and the secondary coil 21 on the vehicle side are opposed in the vertical direction. The wireless power transfer system 1 transmits power from the primary coil 11 of the power transmission device 10 to the secondary coil 21 of the power reception device 20 in a non-contact manner while the vehicle 3 is traveling on the road 4.

Driving in this description means the state in which the vehicle 3 is located on the road 4 for driving. During travel, a state in which the vehicle 3 is temporarily stopped on the road 4 is also included. A state in which the vehicle 3 is stopped on the road 4, for example, by waiting for a signal, is also included during running. On the other hand, even in a state where the vehicle 3 is located on the road 4, for example, when the vehicle 3 is parked and stopped, not included in the running.

In addition, in this explanation, the lane in which the primary coil 11 (segment 7) is embedded is referred to as a D-WPT lane. In some cases, a section of the road 4 where wireless power transmission can be performed by the supply device 5 is referred to as a D-WPT charging site. In the D-WPT lane and D-WPT charge site, a plurality of primary coils 11 (a plurality of segments 7) are installed side by side in the direction of travel of the vehicle 3 over a predetermined section of the road 4.

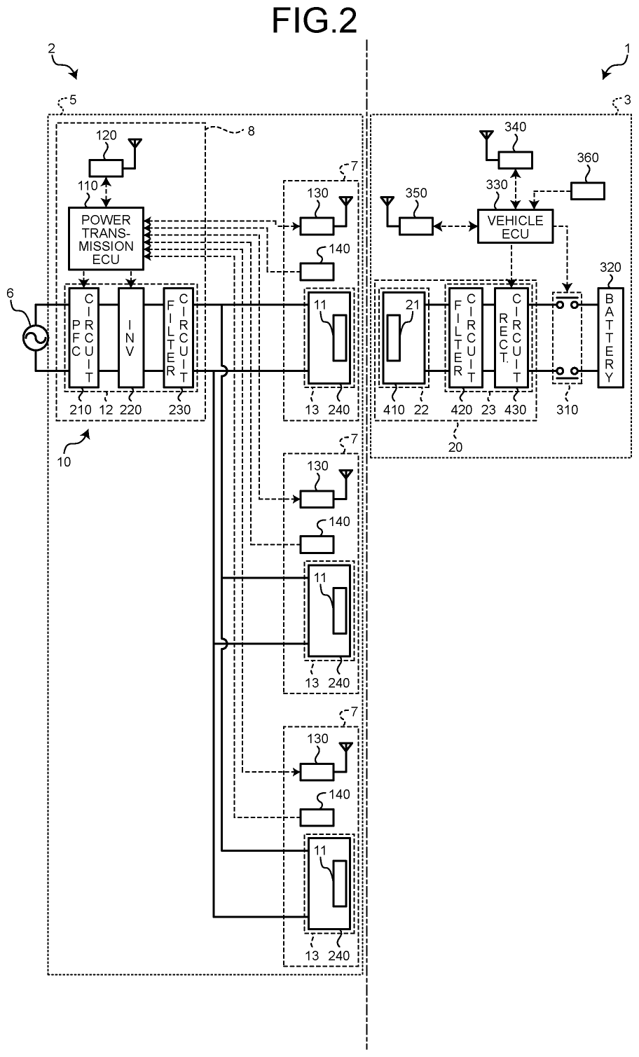

FIG. 2 is a diagram illustrating the overall configuration of a wireless power transfer system. In the supply facility 2, the supply device 5 and the AC power source 6 are electrically connected. In the supply device 5, the segment 7 and the management device 8 are electrically connected.

The supply device 5 includes a configuration provided in the management device 8, and a configuration provided in the segment 7. The supply device 5 includes a power transmission device 10, a power transmission ECU (Electronic Control Unit) 110, a first communication device 120, a second communication device 130, and a foreign material detection device 140.

The power transmission device 10 includes an electrical circuit connected to an AC power source 6. The power transmission device 10 includes a Power Factor Correction (PFC) circuit 210, an inverter (INV) 220, a filtering circuit 230, and a power transmission-side resonant circuit 240.

The PFC circuit 210 improves the power factor of the AC power inputted from the AC power source 6 and converts the AC power into DC power to be outputted to the inverter 220. The PFC circuit 210 includes AC/DC converters. The PFC circuit 210 is electrically connected to the AC power source 6.

The inverter 220 converts the DC power inputted from PFC circuit 210 to AC power. Switching elements of the inverter 220 is constituted by such as IGBT (Insulated Gate Bipolar Transistor) and MOSFET (Metal-Oxide-Semiconductor Field Effect Transistor), performs a switching operation in accordance with a control signal from the power transmission ECU 110. For example, the drive frequency of the inverters 220 is 85 kHz. The inverter 220 outputs the converted AC power to the filter circuit 230.

The filter circuit 230 removes the noise contained in the AC current input from the inverter 220, and supplies the AC power from which the noise has been removed to the power transmission side resonance circuit 240. The filter circuit 230 is a LC filter that combines a coil-capacitor. For example, the filter circuit 230 is constituted by a T-type filter in which two coils and one capacitor are arranged in T-shape. The PFC circuit 210, the inverter 220, and the filter circuit 230 constitute a power converting section 12 of the power transmission device 10.

Transmission side resonance circuit 240 is a power transmission unit for transmitting the AC power supplied from the filter circuit 230 to the power receiving apparatus 20 in a non-contact. When AC power is supplied from the filter circuit 230 to the power transmission side resonance circuit 240, a current flows through the primary coil 11, a magnetic field for power transmission is generated.

The power transmission-side resonance circuit 240 includes a primary coil 11, a resonant capacitor. The primary coil 11 is a power transmission coil. The resonant capacitor is connected in series to one end of the primary coil 11 to adjust the resonance frequency of the power transmission side resonant circuit. This resonant frequency is 10 kHz˜100 GHz, preferably 85 kHz. For example, the power transmission device 10 is configured such that the resonance frequency of the power transmission side resonance circuit 240 and the drive frequency of the inverter 220 coincides. The power transmission side resonance circuit 240 constitutes the primary device 13 of the power transmission device 10.

The power transmission device 10 includes a power conversion unit 12 and a primary device 13. The power converter 12 includes the PFC circuit 210, the inverter 220, and the filtering circuit 230. The primary device 13 includes a transmission side resonant circuit 240. The power transmission device 10 has a configuration in which the power conversion unit 12 is provided in the management device 8 and the primary device 13 is provided in the segment 7.

In the supply device 5, a power converting unit 12 of the power transmitting device 10, a power transmission ECU 110, and a first communication device 120 are provided in the managing device 8, and a primary device 13 of the power transmitting device 10, a second communication device 130, and a foreign material detecting device 140 are provided in the segments 7.

The power transmission ECU 110 is an electronic control unit which controls the supply device 5. The power transmission ECU 110 includes a processor and memories. The processor consists of a Central Processing Unit (CPU), a Digital Signal Processor (DSP), a Field-Programmable Gate Array (FPGA), etc. The memories are main storage devices, such as a Random Access Memory (RAM) and a Read Only Memory (ROM). The power transmission ECU 110 loads the program stored in the storage unit into the work area of the memory (main storage device) and executes the program, and controls the components, etc. through the execution of the program to realize a function that meets a predetermined purpose. The storage unit consists of a recording medium such as a EPROM (Erasable Programmable ROM, a hard disk drive (Hard Disk Drive: HDD), and a removable medium. The removable media includes disc recording media such as a Universal Serial Bus (USB) memory, a Compact Disc (CD), a Digital Versatile Disc (DVD), and a Blu-ray (registered trademark) Disc (BD). The storage unit can store an operating system (OS), various programs, various tables, various databases, etc. Signals from various sensors are inputted into the power transmission ECU 110. Signals from the foreign material detecting device 140 is inputted to the power transmission ECU 110. Then, the power transmission ECU 110 executes various controls based on signals inputted from various sensors.

For example, the power transmission ECU 110 executes power control to adjust the power for transmission. In power control, the power transmission ECU 110 controls the power transmission device 10. The power transmission ECU 110, in order to control the power supplied from the power conversion unit 12 to the primary device 13, and outputs a control signal to the power conversion unit 12. The power transmission ECU 110 controls the switching element included in the PFC circuit 210 to adjust the power for power transmission, and controls the switching element included in the inverter 220 to adjust the power for power transmission.

In addition, the power transmission ECU 110 executes communication control for controlling communication with the vehicles 3. In communication control, the power transmission ECU 110 controls the first communication device 120 and the second communication device 130.

The first communication device 120 is a ground-side communication device that performs wide-area wireless communication. The first communication device 120 radio communicates with the vehicle 3 that has not approached WPT lane among the vehicles 3 that are traveling on the road 4. The state prior to approaching WPT lanes means that the vehicles 3 are in a position where narrow-area radio communication cannot be performed with the supply device 5.

Wide-area wireless communications are communications with a range from 10 meters to 10 kilometers. Wide-area wireless communication is a communication having a longer communication distance than narrow-area wireless communication. As the wide-area wireless communication, it is possible to use various wireless communication having a long communication distance. For example, 3GPP (registered trademark) and communication compliant with communication standards such as 4G, LTE, 5G, WiMAX developed by IEEE are used for wide-area radio communication. In the wireless power transfer system 1, vehicle information associated with the vehicle identification information (vehicle ID) is transmitted from the vehicle 3 to the supply device 5 by using the wide area radio communication.

The second communication device 130 is a ground-side communication device that performs narrow area wireless communication. The second communication device 130 performs radio communication with the vehicle 3 approaching or entering WPT lane among the vehicles 3 traveling on the road 4. The state of approaching WPT lanes means that the vehicles 3 are in a position capable of performing narrow area radio communication with the supply device 5.

Narrow-area wireless communication is communication with a communication distance of less than 10 meters. The narrow-area wireless communication has shorter communication range than wide-area wireless communication. As the narrow-area wireless communication, it is possible to use various short-range wireless communication communicable in a short communication distance. For example, communication conforming to any communication standard established by IEEE, ISO, IEC or the like is used for narrow area radio communication. As an example, Wi-Fi (registered trademark), Bluetooth (registered trademark) and ZigBee (registered trademark) are used for narrow area wireless communication. Alternatively, as a technique for performing narrow area radio communication, a Radio Frequency Identification (RFID), a Dedicated Short Range Communication (DSRC), etc. may be used. In the wireless power transfer system 1, the vehicle identification information or the like is transmitted from the vehicle 3 to the supply device 5 by using the narrow area wireless communication.

The foreign material detecting device 140 detects a metallic foreign material, a living body, or the like existing above the primary coil 11. Foreign object detecting device 140 is constituted by, for example, a sensor coil or an imaging device installed on the ground. The foreign material detection device 140 is for exhibiting a foreign material detection function (Foreign Object Detection: FOD) and a biological protective function (Living Object Protection: LOP) in the wireless power transfer system 1.

In the supply device 5, the configuration of the power transmission device 10 is arranged divided into a segment 7 and a management device 8, and three segments 7 are connected to one management device 8. The power transmission device 10 is configured such that one inverter supplies power to the three transmission side resonance circuits 240. Further, in the supply device 5, a signal from each segment 7 is input to the management apparatus 8. Signals from the second communication device 130 and the foreign material detection device 140 provided in the first segment are inputted into a power transmission ECU 110. Similarly, the signals from the second communication device 130 and the foreign material detecting device 140 provided in the second segment are inputted into the power transmission ECU 110. Signals from the second communication device 130 and the foreign material detection device 140 provided in the third segment are inputted into the power transmission ECU 110. The power transmission ECU 110 can grasp the state of each segment 7 based on the signaling inputted from each segment 7.

The vehicle 3 includes a power reception device 20, a charging relay 310, a battery 320, a vehicle ECU 330, a third communication device 340, a fourth communication device 350, and a Global Positioning System (GPS) receiver 360.

The power reception device 20 supplies the power received from the power transmission device 10 to the battery 320. The power reception device 20 is electrically connected to the battery 320 through a charging relay 310. Power reception device 20 includes a power receiving side resonance circuit 410, a filter circuit 420, and a rectifier circuit 430.

The power receiving side resonance circuit 410 is a power receiving unit that receives the power transmitted from the power transmission device 10 in a non-contact manner. The power receiving side resonance circuit 410 includes a secondary coil 21, and a power receiving side resonance circuit and a resonance capacitor. The secondary coil 21 is a power receiving coil that receives the power transmitted from the primary coil 11 in a non-contact manner. The resonance capacitor is connected in series with one end of the secondary coil 21, to adjust the resonance frequency of the power receiving side resonance circuit 410. The resonance frequency of the power receiving side resonance circuit 410 is defined to coincide with the resonance frequency of the power transmission side resonance circuit 240.

The power receiving side resonance circuit 410 resonance frequency is the same as the resonance frequency of the power transmission side resonance circuit 240. Therefore, when the magnetic field by the power transmission side resonance circuit 240 in a state where the power receiving side resonance circuit 410 faces the power transmission side resonance circuit 240 is generated, the vibration of the magnetic field is transmitted to the power receiving side resonance circuit 410. The primary coil 11 and the secondary coil 21 become a resonance state. When an induced current flows in the secondary coil 21 by electromagnetic induction, an induced electromotive force is generated in the power receiving side resonance circuit 410. The power receiving side resonance circuit 410 receives the power transmitted in a non-contact manner from the power transmission side resonance circuit 240 in this way. Then, the power receiving side resonance circuit 410 supplies the power received from the power transmission side resonance circuit 240 to the filter circuit 420. The power receiving side resonance circuit 410 constitutes the secondary device 22 of the power reception device 20.

The filter circuit 420 removes noise contained in the AC current input from the power receiving side resonance circuit 410, and outputs the AC power from which the noise has been removed to the rectifier circuit 430. The filter circuit 420 is a LC filter that combines a coil-capacitor. For example, the filter circuit 420 is constituted by a T-type filter in which two coils and one capacitor are arranged in T-shape.

The rectifier circuit 430 converts the AC power input from the filter circuit 420 to DC power and outputs it to the battery 320. The rectifier circuit 430, for example, four diodes as a rectifying element is constituted by a full-bridge circuit which is full-bridge connected. Each diode of the rectifier circuit 430 switching elements are connected in parallel. The respective switching elements of the rectifier circuit 430 is constituted by a IGBT, performs a switching operation in response to a control signal from the vehicle ECU 330. The rectifier circuit 430 supplies the converted DC power to the battery 320. The filter circuit 420 and the rectifier circuit 430 constitute a power conversion unit 23 of the power reception device 20.

The power reception device 20 includes a secondary device 22 and a power conversion unit 23. The secondary device 22 includes a power receiving side resonance circuit 410. The power converter 23 includes the filter circuit 420, and the rectifier circuit 430.

The charging relay 310 is provided between the rectifier circuit 430 and the battery 320. The open/close state of the charge-relay 310 is controlled by ECU 330 of vehicles. When the battery 320 is charged by the power transmission device 10, the charging relay 310 is controlled to be in a closed state. When the charging relay 310 is closed, the rectifier circuit 430 and the battery 320 are electrically connected. If the charging relay 310 is in the open state, the space between the rectifier circuit 430 and the battery 320 is de-energized. For example, if the charging relay 310 is in the open state, the vehicle 3 does not make a power supply request.

The battery 320 is a DC power source capable of charging, and is constituted by, for example, a lithium ion battery or a nickel-metal hydride battery. The battery 320 stores the power supplied from the power transmission device 10 to the power reception device 20. Further, the battery 320 can supply power to the traveling motor of the vehicle 3. The battery 320 is electrically connected to the traveling motor via a Power Control Unit (PCU). The PCU is a power converter that converts the DC power of the battery 320 into AC power and supplies it to the traveling motor. The switching elements of the PCU are composed of IGBT and perform the switching operation according to the control signaling of the car ECU 330 et al.

The vehicle ECU 330 is an electronic control device for controlling the vehicle 3. The car ECU 330 is configured in the same way as the power transmission ECU 110 as a hardware-based configuration. Signals from various sensors mounted on the vehicle 3 are inputted to the vehicle ECU 330. In addition, a positioning signal received by GPS receiver 360 is inputted into the vehicle ECU 330. The vehicle ECU 330 may obtain the present location of the vehicle 3 from GPS receiver 360. Then, the vehicle ECU 330 executes various controls based on signals inputted from various sensors.

For example, the vehicle ECU 330 executes a non-contact charge control to transmit power from the primary coil 11 to the secondary coil 21 in a non-contact manner and to store the power received by the secondary coil 21 in the battery 320. In the non-contact charging control, the vehicle ECU 330 controls the rectifier circuit 430, the charging relay 310, the third communication device 340, and the fourth communication device 350. The non-contact charging control includes a power control for controlling the charging power and a communication control for controlling the communication between the supply device 5. In power control, the vehicle ECU330 controls the switching elements included in the rectifier circuit 430, adjusts the power supplied from the power reception device 20 to the battery 320 (charging power). In communication control, the vehicle ECU330 controls the third communication device 340 and the fourth communication device 350.

The third communication device 340 is a communication device on the vehicle side that performs wide-area wireless communication. The third communication device 340 performs radio communication with the first communication device 120 of the supply device 5 in a condition prior to the vehicle 3 traveling on the road 4 approaching WPT lane. The wide-area wireless communication is a two-way wireless communication. The communication between the first communication device 120 and the third communication device 340 is performed by high-speed wireless communication.

The fourth communication device 350 is a communication device on the vehicle side that performs narrow area wireless communication. The fourth communication device 350 performs radio communication with the second communication device 130 of the supply device 5 while the vehicles 3 are approaching or entering WPT lanes. The narrow-area wireless communication is simplex wireless signaling. Unidirectional radio signaling is Peer to Peer Signaling (P2PS). The P2PS is used to notify the vehicle identification from the vehicle 3 to the supplier 5 in each activity of pairing, alignment checking, magnetic coupling checking, performing power transmission, and terminating power transmission. The P2PS can also be used as a Alignment check for lateral alignment checking. The lateral direction is the width direction of the lane, and is the width direction of the vehicle 3.

The GPS receiver 360 detects the present position of the vehicles 3 based on the positioning information obtained from the plurality of positioning satellites. The present position of the vehicle 3 detected by GPS receiver 360 is transmitted to the vehicle ECU330.

Incidentally, the supply device 5, the filter circuit 230 is not segment 7 may be included in the management apparatus 8. That is, the filter circuit 230 may be installed beside the road 4. In this instance, the power converter 12 includes the PFC circuit 210, the inverter 220, and the filtering circuit 230, and the primary device 13 includes a transmission-side resonant circuit 240.

The filter circuit 230 may be provided individually primary coil 11, or may be provided collectively in a plurality of primary coils 11.

The filter circuit 230 is not limited to the T-type filter, for example, a coil and a capacitor may be a band-pass filter connected in series. This also applies to the filter circuit 420 of the vehicle 3.

Further, in the power transmission device 10, when the inverter 220 is connected to a plurality of primary coils 11, a switching switch for switching the primary coil 11 to be energized may be provided in each of the primary devices 13. This switch may be provided on the management device 8 beside the road 4, or may be provided near the primary coil 11.

The power transmission side resonance circuit 240 is not limited to a configuration in which the primary coil 11 and the resonance capacitor are connected in series. The primary coil 11 and the resonant capacitor may be connected in parallel or may be a combination of parallel and series. In short, the power transmission side resonance circuit 240, the resonance frequency of the power transmission side resonance circuit 240 may be configured to match the drive frequency of the inverter 220, the connection relationship of the components is not particularly limited. This is the same for the power receiving side resonance circuit 410 of the vehicle 3.

The driving frequency of the inverter 220 is not limited to 85 kHz, it may be a frequency in the vicinity of 85 kHz. In short, the drive frequency of the inverter 220 may be a predetermined frequency band including 85 KHz.

The power transmission device 10 may be a configuration in which a plurality of inverters 220 are connected to the output-side power line of the PFC circuit 210 (DC power line).

The foreign material detecting device 140 is not limited to the ground side, it may be provided on the vehicle 3 side. For example, when the foreign material detecting device on the side of the vehicle 3 detects a foreign material, a living body, or the like existing above the primary coil 11, it can be configured to stop the power supply request until the vehicle 3 passes too far through the primary coil 11.

Further, in the wireless power transfer system 1, the information transmitted from the vehicle 3 to the supply device 5 by using the narrow area wireless communication, in addition to the vehicle identification information, includes a power supply request and, power supply power request value, and the like. The power supply request is information indicating that the power transmission from the primary coil 11 is requested. The power supply power request value is a request value of the amount of power transmitted from the supply device 5 to the vehicle 3. The vehicle ECU 330 may calculate a feed power demand based on SOC of the battery 320.

The wireless power transfer system 1 is not limited to the power supply method from the ground to the vehicle 3, it is also possible to realize a power supply method from the vehicle 3 to the ground. In this case, the rectifier circuit 430 is replaced with an inverter, can be realized rectification at the time of power supply or power reception.

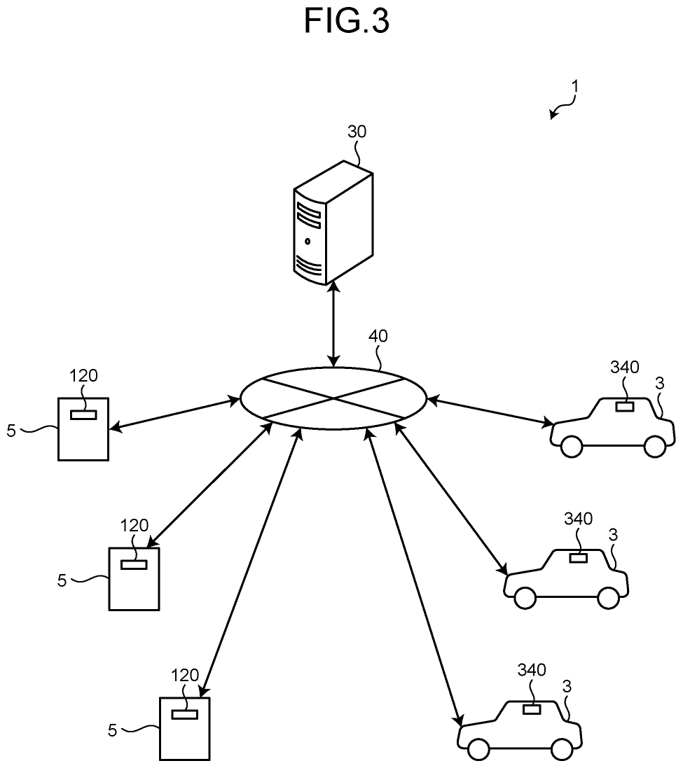

FIG. 3 is a schematic diagram for explaining wide-area wireless communication in a wireless power transfer system.

In the wireless power transfer system 1, the vehicle 3 can communicate with the server 30, and the supply device 5 can communicate with the server 30.

The server 30 is connected to the network 40 and can communicate with the plurality of vehicles 3 and the plurality of supply devices 5 through the network 40. The network 40 is composed of a Wide Area Network (WAN) which is a public communication network such as the internet and a telephone communication network of the portable telephone.

The vehicle 3 is connected to the network 40 by wide area wireless communication using the third communication device 340. The vehicle 3 transmits information to the server 30 and receives information from the server 30.

The Supply device 5 is connected to the network 40 by wide area wireless communication using the first communication device 120. The supply device 5 transmits information to the server 30 and receives information from the server 30.

The server 30 processes information regarding wireless power transmission between the vehicle 3 and the supply device 5. The server 30 includes a communication device and a control device. This controller is configured in the same way as the power transmission ECU 110 as a hardware-based configuration. The server 30 creates various lists related to wireless power transmission on the basis of information received from the vehicle 3 and information received from the supply device 5. Then, the server 30 provides necessary information about the wireless power transmission to the necessary vehicle 3 and the supply device 5 at the necessary timing based on various lists. In the wireless power transfer system 1, communication between the vehicle 3 and the supply device 5 through the server 30 is possible using the wide-area wireless communication. The traveling vehicle 3 transmits the vehicle identification information (vehicle ID) to the server 30, and the server 30 transmits the vehicle information associated with the vehicle identification information to the supply device 5.

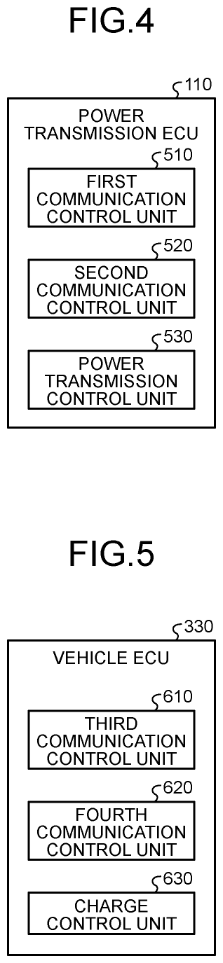

FIG. 4 is a block diagram illustrating the functional configuration of the power transmission ECU.

The power transmission ECU 110 includes a first communication control unit 510, a second communication control unit 520, and a power transmission control unit 530.

The first communication control unit 510 executes first communication control for controlling the first communication device 120. The first communication control is for controlling the wide area wireless communication of the supply device 5 side, and controls the communication of the supply device 5 using the first communication device 120. That is, the first communication control controls the communication of the management device 8 of the supply device 5. The first communication control controls communication between the supply device 5 and the network 40 and controls communication between the supply device 5 and the server 30 through the network 40. The first communication control unit 510 is a Supply Equipment Communication Controller (SECC).

The second communication control unit 520 executes the second communication control for controlling the second communication device 130. The second communication control is for controlling the narrow area wireless communication of the supply device 5 side, and controls the communication of the supply device 5 using the second communication device 130. That is, the second communication control controls the communication of the segment 7 of the supply device 5. The second communication control controls communication between the supply device 5 and the vehicle 3 as communication not through the network 40. The second communication control unit 520 is a Primary Device Communication Controller (PDCC).

The power transmission control unit 530 executes power transmission control for controlling the power transmission device 10. The transmission control is for controlling the power for transmission, and controls the power conversion unit 12 of the power transmission device 10. The power transmission control unit 530 executes power control for controlling the PFC circuit 210 and the inverters 220.

FIG. 5 is a block diagram illustrating the functional configuration of a rolling stock ECU.

The vehicle ECU 330 includes a third communication control unit 610, a fourth communication control unit 620, and a charge control unit 630.

The third communication control unit 610 executes the third communication control for controlling the third communication device 340. The third communication control is for controlling the wide area wireless communication of the vehicle 3 side, and controls the communication of the vehicle 3 using the third communication device 340. The third communication control controls the communication between the vehicle 3 and the network 40 and controls the communication between the vehicle 3 and the server 30 through the network 40.

The third communication control unit 610 is an EV Communication Controller (EVCC).

The fourth communication control unit 620 executes fourth communication control for controlling the fourth communication device 350. The fourth communication control is to control the narrow area wireless communication of the vehicle 3 side, and controls the communication of the vehicle 3 using the fourth communication device 350. The fourth communication control controls communication between the vehicle 3 and the supply device 5 as communication not through the network 40. The fourth communication control unit 620 is a Secondary Device Communication Controller (SDCC).

The charging control unit 630 executes the charging control for controlling the power reception device 20 and the charging relay 310. The charge control includes a power control to control the received power at the secondary device 22 and a relay control to control the connection state between the secondary device 22 and the battery 320. The charging control unit 630 executes a power control for controlling the rectifier circuit 430. The charge control unit 630 executes the relay control for switching the open-close state of the charging relay 310.

In the wireless power transfer system 1 configured in this way, in a state where the wireless communication between the vehicle 3 and the supply device 5 is established, the wireless power transmission from the supply device 5 to the vehicle 3 is performed. In a state where pairing between the vehicle 3 and the supply device 5 is performed by wireless communication, power is transmitted in a non-contact manner from the primary coil 11 on the ground side to the secondary coil 21 on the vehicle side. Then, the vehicle 3 charging control for supplying the power secondary coil 21 is received to the battery 320.

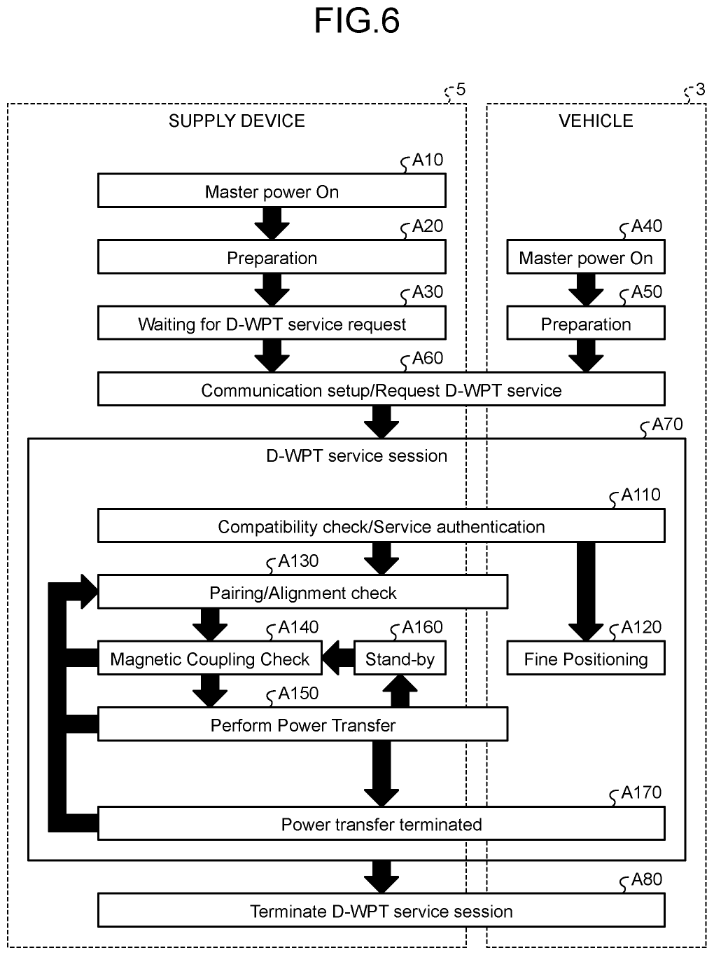

Next, referring to FIG. 6, the power transmission process (D-WPT process) is described. The power transfer process is structured as a chain of multiple activities, and is a process derived from states and corresponding transitions.

FIG. 6 is a diagram for explaining a power transmission process. In FIG. 6, the basic activities for describing the power transfer process are illustrated. Thick arrows illustrated in FIG. 6 represent transition lines. The state of the wireless power transfer system 1 in the power transmission process is represented by the activities constituting the power transmission process.

Activities constituting a power transmission process include a power transmission service session (D-WPT service session A70), which is an activity of the stage performing power transmission, and an activity of the stage prior to performing power transmission and an activity of the stage after performing power transmission. Activity, depending on the presence or absence of communication between the supply device 5 and the vehicle 3, it is possible to describe separately the operation main. Activities are divided into those representing the state of only the supply device 5 side without communication, those representing the state of only the vehicle 3 side without communication, and those representing the state of both the supply device 5 with communication and the vehicle 3.

As illustrated in FIG. 6, the master power supply is turned on (Master power On) A10), the master power supply is turned on (Preparation) A20, waiting for a request from Vehicle 3, the master power supply is turned on (Master power On) A40, Preparation) A50, the communication setting (Communication setup) and the request for D-WPT service (Request D-WPT service) A60, D-WPT service session (D-WPT service session) A70, and Waiting for D-WPT service request) A30) and the termination of D-WPT service session).

The preparation A20 is a preparation condition of the supply device 5. In the readiness A20, the supply device 5 performs activation and safety check of the circuitry without communication with the vehicle 3. The supply device 5 transits to a state of ready A20 when the master power supply is turned to an on-state A10. Then, if the supply device 5 in the ready A20 can confirm the safety by activating the circuitry, the state changes to wait for a request from the vehicle 3 (Waiting for D-WPT service request) A30). On the other hand, if there is a problem in the supply device 5, the supply device 5 by wide area wireless communication, notifying the vehicle 3 information indicating that the wireless power transfer system 1 cannot be used (unavailable notification). The first communication device 120 transmits an unavailable notification to the vehicle 3.

The preparation A50 is a preparation condition of the car 3. In the readiness A50, the car 3 performs startup and safety confirmation of the circuitry without communicating with the supply device 5. The vehicle 3 transits to a state of ready A50 when the master power supply is turned to an on-state A40. Then, if the vehicle 3 is able to confirm the safety by activating the circuit in the preparatory A50, the state transits to the communication setting (Communication setup) and the request for D-WPT servicing (Request D-WPT service) A60). On the other hand, if the vehicle 3 is problematic, the vehicle 3 does not initiate wide area radio communication and does not perform subsequent sequencing in D-WPT processing.

The required A60 of communication settings and D-WPT servicing is initiated by the vehicle ECU 330.

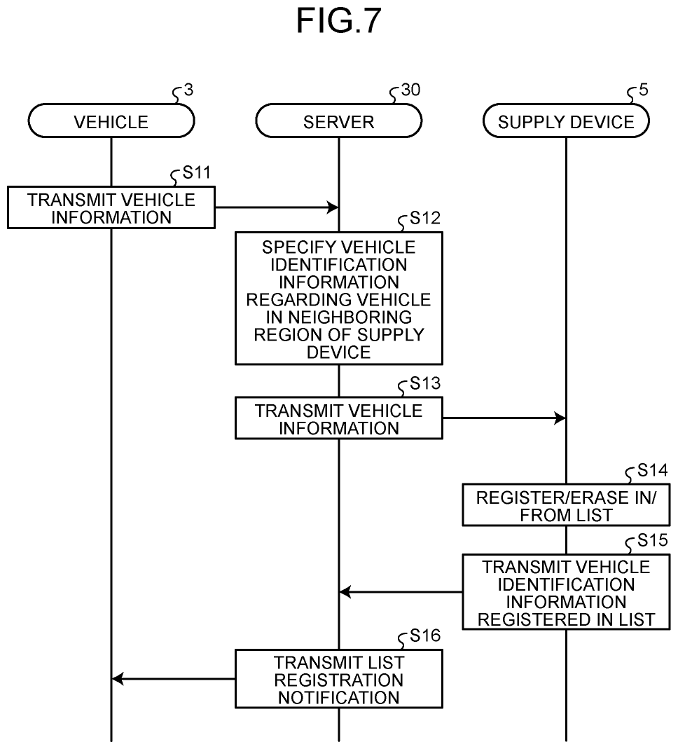

In the required A60 of communication setting and D-WPT servicing, the vehicle ECU 330 initiates wide area radio communication. First, when the vehicles 3 change from the ready A50 to the request A60 of the communication setting and D-WPT service, the third communication device 340 transmits the request signal of D-WPT service. The third communication device 340 performs radio communication with the first communication device 120 corresponding to D-WPT lanes that the vehicles 3 are scheduled to enter or have entered. The communication target first communication device 120 is selected based on the relative positional relation between the present position of the vehicle 3 and the position of D-WPT lane. In the supply device 5, in the state of the request waiting A30 from the vehicle 3, when the first communication device 120 receives the request signal of D-WPT service, the state transits to the request A60 of the communication setting and D-WPT service. Various types of information between wide-area radio communication and P2PS communication are linked using vehicle-identification information. FIG. 7 illustrates the processing sequence of the request A60 of this communication setting and D-WPT service.

FIG. 7 is a sequence diagram illustrating a case in which communication using wide-area wireless communication is performed between the vehicle and the supply device. The vehicle 3 transmits the vehicle data to the servers 30 (step S11). In step S11, the third communication device 340 of the vehicle 3 transmits the vehicle data to the server 30. The vehicle information includes vehicle identification information, various parameters of the power reception device 20, the current position information of the vehicle 3, and the required power. The vehicle ECU 330 calculates the requested power based on State Of Charge (SOC) of the battery 320. In the stepping S11, the vehicle ECU 330 transmits the vehicle data from the third communication device 340 at predetermined times. The predetermined times are set according to the distances from the present position of the vehicles 3 to the start points of WPT lanes. The shorter the distance from the car 3 to the start point of WPT lane, the shorter the interval for a predetermined period of time.

When receiving the vehicle information from the vehicle 3, the server 30 specifies the vehicle identification information of the vehicle 3 located in the vicinity area of the supply device 5 on the basis of the present position information of the vehicle 3 included in the vehicle information (step S12).

In step S12, the servers 30 identify the vehicles 3 located within the predetermined neighborhood area from the supply device 5 based on the present position information of the vehicles 3 and the position information of the supply device 5. Near area is set to a region within, for example, 500 meters.

The server 30 transmits the vehicle information to the supply device 5 when the vehicle identification information of the vehicle 3 is specified (step S13). In step S13, the transmitter of the server 30 transmits the vehicle-information to the supplier 5.

Upon receiving the vehicle information from the servers 30, the supply device 5 registers and erases the vehicle identification information in the identification information list (step S14). In step S14, the power transmission ECU 110 registers and erases the vehicle identification information in the identification information list so that the vehicle identification information associated with the vehicle information is registered in the identification information list without excess or deficiency.

The supply device 5 transmits the vehicle identification information registered in the identification information list to the server 30 when registration/erasure of the vehicle identification information to the identification information list is performed (step S15). In step S15, the first communication device 120 of the supply device 5 transmits the vehicle-identification-information to the server 30.

Then, when receiving the vehicle identification information from the supply device 5, the server 30 transmits the list registration notification to the vehicle 3 corresponding to the vehicle identification information registered in the identification information list (Step S16). In step S16, the communication devices of the servers 30 transmit list-registration notifications to the vehicles 3. The list registration notification is a notification indicating that the vehicle identification information is registered in the identification information list and includes identification information of the supply device 5 and position information of the supply device 5.

Thus when the vehicle 3 starts wide area wireless communication and the supply device 5 and the vehicle 3 are both the state of the required A60 of the communication setting and D-WPT service, it is that the communication setting by the wide area wireless communication is successful. The state changes to D-WPT service-session (D-WPT service session) A70) due to successful communication configuration.

Return back to FIG. 6. The D-WPT service session A70 transmits power from the power transmission side resonance circuit 240 of the state device 5 to the power reception side resonance circuit 410 of the vehicle 3 in a non-contact manner while a communication connection is established between the supply device 5 and the vehicle 3. The D-WPT Service-Session A70 begins with a successful communication configuration and ends upon completion of the communication. The state changes to D-WPT service session end (Terminate D-WPT service session) A80) when communication ends in D-WPT service session A70 status.

In the termination A80 of D-WPT service session, the vehicles 3 terminate the wide area radio communication with the supply device 5. The vehicles 3 and the supply device 5 can receive a trigger to terminate D-WPT service session A70. The vehicle ECU 330 then prevents D-WPT from being initiated for the secondary device 22 and the vehicle 3 until the third communication device 340 receives the following notification (D-WPT servicing demand).

This section describes the detailed activities of D-WPT service-session A70.

The D-WPT service session A70 includes compatibility check (Compatibility check) and service certification (Service authentication) A110), detailed alignment (Fine Positioning) A120), pairing (Pairing) and alignment check (Alignment check) A130), magnetic coupling check (Magnetic Coupling Check) A140), execution of power transmission (Perform Power Transfer) A150, standby (Stand-by) A160, and terminate of power transfer (Power transfer terminated) A170).

The compatibility checking and service-authentication A110 are described. After the successful communication setting, the vehicle ECU 330 and transmission ECU 110 confirm that the primary device 13 and the secondary device 22 are compatible. The compatibility check is performed on the supply device 5 side on the basis of the information associated with the vehicle identification information acquired by the communication.

Check items include the minimum ground height of the secondary device 22, the shape type of the power receiving side resonance circuit 410, the circuit topology of the secondary device 22, the self-resonant frequency of the secondary device 22, the number of secondary coils 21, and the like.

In the compatibility check and service authentication A110, first, the vehicle 3 transmits the compatibility information (Compatibility Information) of the power reception device 20 from the third communication device 340 to the supply device 5. The compatibility information of the power reception device 20 is transmitted by the wide-area wireless communication. The first communication device 120 of the supply device 5 receives the compatibility information of the power reception device 20 from the vehicle 3. The first communication device 120 of the supply device 5 transmits the compatibility information of the power transmission device 10 to the vehicle 3. The compatibility information of the power transmission device 10 is transmitted by the wide area wireless communication. The third communication device 340 of the vehicle 3 receives the compatibility information of the power transmission device 10 from the supply device 5. These compatibility information can be transmitted and received between the vehicle 3 and the supply device 5 by wide area wireless communication through the network 40 and the server 30.

The elements of the compatibility information the vehicles 3 transmit to the supplier 5 include vehicle identification information, WPT power classes (WPT Power Classes), gap classes (Air Gap Class), WPT drive frequencies (WPT Operating Frequencies), WPT frequency adjustment, WPT types (WPT Type), WPT circuitry topology (WPT Circuit Topology), detailed alignment methods (Fine Positioning Method), pairing methods (Pairing Method), alignment methods (Alignment Method), presence/absence information of power adjustment functions, and the like.

The elements of the compatibility information the supplier 5 transmits to the vehicle 3 include: supply device identification information, WPT power classes, WPT drive frequencies, WPT frequency adjustment, WPT types, WPT circuitry topologies, detailed alignment methods, pairing methods, alignment methods, presence or absence of power adjustment functions, and the like.

Each element name is described in detail. Incidentally, describes each element of the compatibility information transmitted from the vehicle 3 to the supply device 5, those duplicate the compatibility information transmitted from the vehicle 3 to the supply device 5 of the compatibility information transmitted from the supply device 5 to the vehicle 3 will be omitted.

The gap class is information indicating the gap class that the secondary device 22 can receive power.

WPT power class is information indicating the power class that the secondary device 22 can receive power. The WPT driving frequency is informational indicating the frequency of the received power received by the secondary device 22. The WPT frequency adjustment is informational indicating whether the adjustment of the drive frequency. The WPT type is information indicating the shape type of the power receiving-side resonant circuit 410, and illustrates the coil shape of the secondary coil 21. There are circular and solenoidal types as WPT types. The WPT topology is information indicating the interconnection between the secondary coil 21 and the resonant capacitor. The WPT topologies include series and parallel. The detailed alignment method is information indicating how to perform the alignment when performing the alignment. The pairing method refers to the method that the vehicle 3 performs a pairing to identify the supply device 5. The alignment method refers to the method how to locate the secondary device 22 and the primary device 13 relative to each other before the start of transmission.

The detailed alignment A120 will be described. The vehicle 3 performs detailed alignment A120 prior to or in parallel with the pairing and alignment checking A130. The vehicle ECU 330 starts a detailed alignment A120 when it determines that the vehicle 3 has approached or entered the installed area (D-WPT lanes) of the supply device 5.

The vehicle ECU 330 induces the vehicle 3 to align the primary device 13 with the secondary device 22 within an area that establishes adequate magnetic coupling for wireless power transmission.

The detailed alignment A120 is basically performed manually or automatically on the car 3. The detailed alignment A120 can be coordinated with ADAS (Automated Driving Assistance System).

Then, the activities of the detailed alignment A120 can continue until the vehicle 3 leaves D-WPT charge site or the state changes to the end of communication, and can be performed based on the alignment information transmitted from the supplier 5 to the vehicle 3 by the wide area radio communication. This communication termination is D-WPT service-session termination A80.

The pairing and alignment checking (Pairing/Alignment check) A130 are described below. Here, it will be described separately pairing (Pairing) and alignment checking (Alignment check).

The pairing will be described. The P2PS interface providing narrow area radio communication ensures that the primary device 13 and the secondary device 22 are uniquely paired. The process of pairing status is as follows.

First, the vehicle ECU 330 recognizes that the vehicle 3 has approached or entered D-WPT lanes. For example, the vehicle ECU 330 has map-based information including D-WPT lanes, and recognizes approaching or approaching in such a straight line distance as compared to the position information of its own vehicle obtained by GPS receiver 360. The vehicles 3 transmit to the servers 30 by wide area radio communication which D-WPT lanes approached. In short, the third communication device 340 notifies the cloud of a signal indicating that the vehicle 3 has approached any of D-WPT lanes. In addition, if the vehicle ECU 330 recognizes the approach or approach to D-WPT lane of the vehicle 3, the fourth communication device 350 starts transmitting the modulated signals at regular intervals for pairing of the primary device 13 with the secondary device 22.

The supply device 5 may recognize that the vehicles 3 have approached or entered D-WPT lanes using the information acquired from the servers 30 by the wide area radio communication. The servers 30 allocate the vehicle identifications of the vehicles 3 approaching in the respective D-WPT lanes to the supply devices 5 corresponding to the lanes. In the supply device 5, since it is sufficient to refer to the vehicle identification information whose number is narrowed by the server 30, the authentication process becomes possible in a short time. When the supply device 5 recognizes that the vehicle 3 is approaching D-WPT lane, the second communication device 130 is in the standby mode. In the standby mode, wait to receive the modulated signal from the fourth communication device 350 of the vehicle 3. This modulation signal includes vehicle identification information.

When the second communication device 130 receives the modulated signal from the vehicle 3, the supply device 5 compares the vehicle identification information received by the narrow area wireless communication with the vehicle identification information in the identification information list obtained by the outcome of the wide area wireless communication with the plurality of vehicles 3 coming toward D-WPT lanes. By this comparison, the supply device 5 identifies the vehicle 3.

The vehicle ECU 330, when recognizing that the vehicle 3 is out of D-WPT lanes, ceases transmitting the modulated signal from the fourth communication device 350. The vehicle ECU 330 can determine whether or not it has passed through D-WPT lanes based on the map-based information and the position information of its own vehicle.

The supply device 5 stops waiting for the modulated signal from the fourth communication device 350 when it is determined that the vehicle 3 is not traveling in D-WPT lane or when it is determined that the vehicle 3 is not approaching D-WPT lane.

The pairing is performed on the primary device 13 until the vehicle 3 exits D-WPT charge site or the state changes to communication termination. When pairing (Pairing) is completed, the state transitions to alignment checking (Alignment check).

The alignment check will be described. The alignment check is intended to ensure that the lateral distance between the primary device 13 and the secondary device 22 is within an acceptable range. The alignment checking is performed using narrow area radio communication (P2PS).

The alignment checking is performed continuously based on P2PS until the vehicles 3 leave D-WPT charge site or the state changes to communication termination. The result of the alignment check may be transmitted from the first communication device 120 to the third communication device 340 by the wide area wireless communication.

A magnetic coupling checking A140 will be described. In the magnetic coupling checking A140, the supply device 5 confirms the magnetic coupling condition and confirms that the secondary device 22 is within the tolerance. When the magnetic coupling checking A140 is finished, the state transits to the running A150 of the power transmission.

It will be described an A150 of executing the power transmission. In this state, the supply device 5 performs power transmission to the power reception device 20. The power transmission device 10 and the power reception device 20 need to have the capability of controlling the transmission power (transmission power and received power) to ensure the usefulness of MF-D-WPT and to protect the power reception device 20 and the battery 320. Larger power transmission helps increase the travel distance of the power reception device 20 without static wireless charging and conductive charging. However, the capacity of the battery 320 varies depending on the vehicle 3 type, the power demand for driving may vary rapidly. As this rapid fluctuation, sudden regenerative braking is mentioned. Since the regenerative braking is prioritized when the regenerative braking is performed while traveling through D-WPT lanes, the power received from the power reception device 20 in addition to the regenerative power will be supplied to the battery 320. In this case, in order to protect the battery 320 from overcharging, adjustment of the transmission power by the power reception device 20 is required.

Despite the need for power control, no new communication is initiated between the supply device 5 and the power reception device 20 in this state. Because communication can compromise response and accuracy in power control due to its instability and latency. Therefore, the supply device 5 and the power reception device 20 perform power transmission and control on the basis of known information up to this state.

The supply device 5 increases the transmission power of the magnetic coupling check for the power request transmitted from the third communication device 340 by using the wide area wireless communication in advance. The supply device 5 maintains current and voltage variations within that range and attempts to maximize the power transmitted during the transition.

The power reception device 20 basically receives the transmission power from the power transmission device 10 without any control. However, the power reception device 20, such as the rated power of the battery 320 that varies according to the charging state and the driving power demand of the vehicle 3, starts control when the transmission power exceeds or is exceeding the limit. The power control in the vehicle ECU 330 is also required to cope with malfunctions in wide-area radio communications. This malfunction leads to a discrepancy between the power control target and the request from the third communication device 340 in the primary device 13, and a sudden failure of the power reception device 20 and the battery 320 in the middle of power transmission. The power reception device 20 controls the power transmitted under the power request rate notified by the first communication device 120.

The power requirements are determined based on compatibility check information such as WPT circuitry topology, geometry, ground clearance, electro-magnetic compatibility (EMC) of the vehicles 3 and the primary devices 13. The magnetic field differs according to these specifications. The power needs to be transmitted within the scope that satisfies the EMC.

The power control in the power transmission ECU 110 and the power reception device 20 may interfere with each other. In particular, there is a possibility of interference when the supply device 5 tries to achieve a power requirement that is greater than the latest power limit in the power reception device 20 by wide area wireless communication. An example of this is rapid regenerative control with a relatively small battery 320 in the vehicle 3. If possible, it would be desirable for the supply 5 to be able to detect a mismatch between the power control target and the limits and to adjust the power transfer to eliminate the mismatch.

For example, if the secondary device 22 is still on the primary device 13 while the power transmission is interrupted for a short period, such as when a foreign object is detected on the primary device 13 by the foreign object detection device 140 or when the coupling factor of the magnetic coupling becomes low due to poor alignment of the secondary device 22, the state transitions to standby (Stand-by) A160). In the case where the foreign material detecting device is provided in the vehicle 3 may detect the foreign material in the vehicle 3 side.

As the secondary device 22 passes over the primary device 13, the state transitions to the termination A170 of the power transfer. In this case, since the magnetic coupling between the two devices is weakened, the transmitted power is reduced. Since the supply device 5 can detect that the magnetic coupling is weakened by monitoring the transmission power, the supply device 5 basically determines the state-transition to the termination A170 of the power transmission and then begins to lower the voltage to halt the power transmission.

Described is the standby A160. In this state, the power transmission is briefly interrupted for some reason, and when D-WPT is ready in both the vehicles 3 and the feeder 5, the state returns to the running A150 of the power transmission. If the power transmission may be interrupted, the state goes into standby A160.

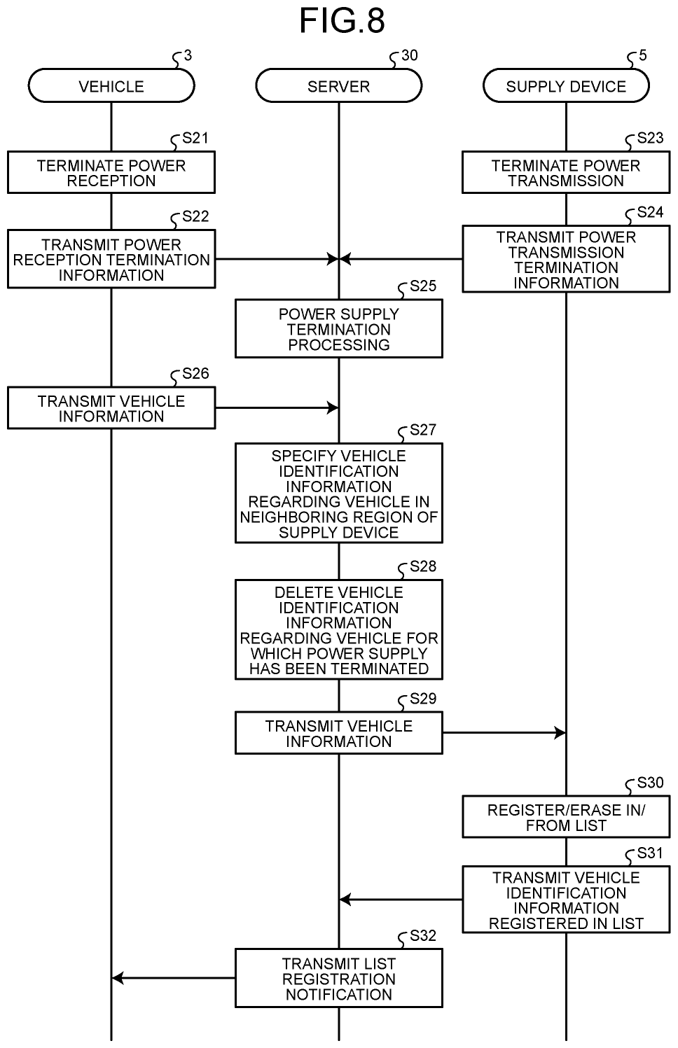

The terminate A170 of the power transmission will be described. In this state, the supply device 5 reduces the transmitted power to zero and retains or uploads the power transmission result data, such as total transmission power, power transmission efficiency, fault history, and the like. The vehicle identification information is tagged to each data. Finally, the supply device 5 deletes the vehicle identity of the vehicle 3 that has passed the D-WPT lanes. Thus, the supply device 5 can be provided for pairing and power transmission to be performed subsequently to other vehicles. FIG. 8 illustrates the process sequence of the termination A170 of the power transmission.

FIG. 8 is a sequence diagram illustrating an operation after the power supply during running from the supply device to the vehicle is completed. When power receiving from the supply device 5 in the power reception device 20 of the vehicle 3 is completed (step S21), the vehicle 3 transmits the power receiving end information to the server 30 (step S22). In step S22, the power receiving end information is transmitted from the third communication device 340 of the vehicle 3. The power receiving end information includes, as information related to power receiving from the supply device 5, for example, vehicle identification information of the vehicle 3, power received from the supply device 5, the power receiving efficiency, and the abnormality detection result.

The supply device 5, when the process of step S21 is performed, terminates the transmission of power to the vehicle 3 (step S23). The processing of step S21 and the processing of step S23 may or may not be performed simultaneously. When the process of step S23 is performed, the supply device 5 transmits the power transmission termination data to the server 30 (step S24). In step S24, the power transmission end information is transmitted from the first communication device 120 of the supply device 5.

The server 30 receives the power reception end information from the vehicle 3, and receives the power transmission end information from the supply device 5, performs a power supply end process to terminate the power supply from the supply device 5 to the vehicle 3 (step S25). In the power supply end process, based on the power reception end information and the power transmission end information, the calculation process of the amount of power supplied from the supply device 5 to the vehicle 3, the vehicle 3 based on the calculated amount of supplied power charging process to the user is performed.

Further, the vehicle 3 transmits the vehicle data to the server 30 irrespective of the power supply termination process (step S26). In step S26, the vehicle data is transmitted from the third communication device 340 of the vehicle 3.

The server 30, upon receiving the vehicle information from the vehicle 3 after the completion of the power supply process, identifies the vehicle identification information of the vehicle 3 located in the vicinity area of the respective supply devices 5 based on the vehicle information (step S27).

Then, if the power supply termination process to a certain vehicle 3 in a certain supply device 5 has already been performed, the server 30, from the vehicle identification information of the vehicle 3 in the vicinity area of the supply device 5 identified in the process of step S27, the vehicle identification information of the vehicle 3 that has already been power supply termination process is performed deleted (step S28).

Thereafter, among the vehicle identification information of the vehicles 3 that are identified to be located in the vicinity area of each supply device 5, the server 30 transmits the vehicle information associated with the vehicle identification information that has not been deleted in the process of step S28 to each supply device 5 (step S29).

After the vehicle information is transmitted to the respective supply devices 5 in the process of the step S29, when the supply device 5 receives the vehicle information from the server 30, the supply device 5 registers and erases the vehicle identification information to the identification information list (step S30). The processing of step S30 is similar to the processing of step S14 of FIG. 7. Thereafter, the supply device 5 transmits the vehicle identification information registered in the identification information list to the server 30 (step S31). The processing of step S31 is similar to the processing of the step S15 of FIG. 7.

Then, when receiving the vehicle identification information from the supply device 5, the server 30 transmits the list registration notification to the vehicle 3 corresponding to the vehicle identification information registered in the identification information list (Step S32). The processing of step S32 is similar to the processing of step S16 of FIG. 7.

As a result, when the process shown in FIG. 8 is performed, with the identification information list is located in the vicinity region of each supply device 5, the supply of the power from the supply device 5 is not completed, and the vehicle identification information for the vehicle 3 has not been erased request of the vehicle identification information, so that the vehicle identification information will be registered. Then, the vehicle 3 receives the list registration notification when the vehicle identification information of the vehicle 3 is registered in the identification information list of any of the supply devices 5. Therefore, the vehicle ECU 330 can determine that the own vehicle is registered in any of the supply devices 5 by receiving the list-registration notification. Then, if the vehicle 3 is out of the vicinity region of the supply device 5, the vehicle identification information of the vehicle 3 from the identification information list of the supply device 5 is erased.

Returned to FIG. 6. Further, at the termination A170 of the power transmission, the power reception device 20, there is no need to do anything in order to zero the transmission power. The P2PS interface is kept active when the vehicle 3 is in D-WPT lanes. The state of the power reception device 20 automatically transitions to pairing for power transmission from the primary device 13. As in the transition line shown in FIG. 6, the state transitions from the termination A170 of the power transmission to the pairing and alignment checking A130. As illustrated in FIG. 6, since the predetermined transition condition is met, it is possible to transition from the magnetic coupling check A140 to the pairing and alignment check A130, and to transition from the execution A150 of the power transmission to the pairing and alignment check A130. The pairing may be performed individually for a plurality of primary coils 11 may be performed at the representative point by bundling a plurality of primary coils 11.

Then, the D-WPT service session A70 transits to the end A80 of D-WPT service session and stops the wide area radio communication between the first communication device 120 and the third communication device 340 when there is no D-WPT request from the vehicle ECU 330 or when a series of states from the request A60 of the communication setting and D-WPT service to the end A170 of the power transmission are prohibited. For example, D-WPT shuts down when the charge condition in the battery 320 is too high or when the power reception device 20 is too hot for continual power transfer. Such unwanted D-WPT can be disabled simply by deactivating P2PS interface. However, by stopping the wide area wireless communication, the power transmission ECU 110 can release the memories occupied for the vehicles 3 without requiring D-WPT by terminating the established wide area wireless communication.

In addition, D-WPT service session A70 is not limited to a transition such as the transition line shown in FIG. 6. In D-WPT service session A70, if the power transmission process remains at D-WPT service session A70 when the activities after the pairing and alignment check A130 are terminated, A80 for terminating D-WPT service session does not transition to the compatibility check and service certification A110. For example, if a predetermined transition criterion is satisfied in the state of the magnetic coupling check A140, the state can transition to the compatibility check and service authentication A110. The transitions of the activities in D-WPT service session A70 are controlled by the controller of the wireless power transfer system 1. The controller of the wireless power transfer system 1 includes a power transmission ECU 110 and the vehicle ECU 330. The power transmission ECU 110 includes functions as a controller of the supply device 5. The vehicle ECU 330 includes functions as a control device of the power reception device 20.

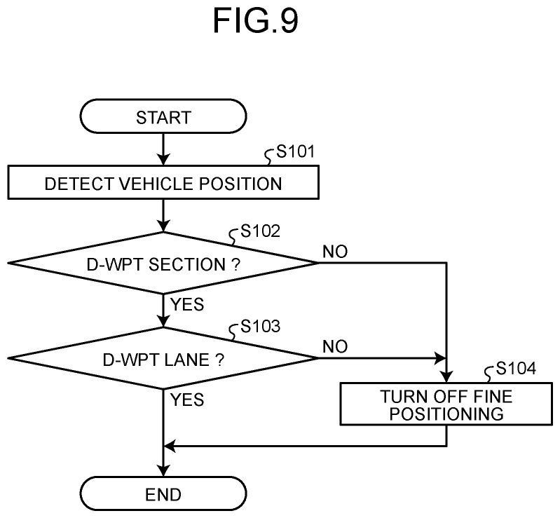

FIG. 9 is a flowchart illustrating the control of the detailed alignment. The control shown in FIG. 9 is implemented by a vehicle ECU 330 with detailed alignment (Fine Positioning) A120 on).

The vehicle ECU 330 detects the position of the vehicle 3 in travel (step S101). In step S101, the position of the vehicle 3 is detected using a position detecting function such as GPS receiver 360 or ADAS.

The vehicle ECU 330 determines whether the vehicle 3 is located in D-WPT section (step S102). The D-WPT section is synonymous with D-WPT charge-site. In step S102, using the vehicle position detected by the stepping S101 and the map information including information of D-WPT section which the vehicle 3 acquired in advance, whether the vehicle 3 in travel is located in D-WPT section is determined.

If the vehicle 3 is determined to be located in the D-WPT section (step S102: Yes), the vehicle ECU 330 determines whether the vehicle 3 is running in D-WPT lanes (step S103). The D-WPT section is not limited to the case having only one lane, but also includes the case having plural lanes. Therefore, the fact that the vehicle 3 is located in D-WPT section does not necessarily coincide with the fact that the vehicle 3 is traveling through D-WPT lanes. Therefore, in step S103, using the vehicle position detected by the stepped S101 and the map information including information of D-WPT lane vehicle 3 has acquired in advance, whether the vehicle 3 in travel is located in D-WPT section is determined. The vehicle ECU 330 can also determine whether or not the running lane is D-WPT lane using beacons, ambient sensors, or the like. The ambient sensor is a sensor mounted on the vehicle 3, which detects the ambient environment of the vehicle 3.

If the vehicle 3 is determined to be traveling through D-WPT lanes (S103: Yes), the control routine ends. The detailed alignment A120 is then maintained as on.

If it is determined that vehicle 3 is not running in D-WPT lanes (step S103:No), the vehicle ECU 330 turns off Fine Positioning (step S104). In step S104, the detailed alignment A120 is switched from on to off. The vehicle ECU 330 turns off the beacons and ambient sensors when the detailed alignment A120 is turned off. In other words, when the detailed alignment A120 is active, the beacon and the sensor for detecting the surroundings are activated. On the other hand, when the detailed alignment A120 is active, the beacon and ambient sensors are stopped. When the process of step S104 is performed, the control routine is terminated.

Further, when it is determined that the vehicle 3 is located outside D-WPT section in the step S102 (step S102: No), the control routine proceeds to step S104.

Vehicle ECU 330, when it is determined that the vehicle 3 is located outside D-WPT section by the determination process of the step S102, it is determined that the vehicle 3 is out of D-WPT section (away from D-WPT site), and terminates the detailed alignment A120 in the step S104.

As described above, according to the embodiment, when the vehicle 3 is being driven outside D-WPT section or outside D-WPT lane, Fine Positioning can be temporarily stopped. Thus, since Fine Positioning is switched off, it is possible to shut down the ambient sensors and beacons that are always activated when Fine Positioning is on. As a result, with respect to the power consumption generated by the ambient sensor and the beacon is activated, it is possible to suppress the ambient sensor and the beacon is unnecessarily activated, it is possible to suppress the wasteful power consumption.

The position detecting function is not limited to GPS receiver 360 and ADAS, and may be a camera-a LiDAR or a sonar.

In addition, on/off switching of Fine Positioning by the time information is enabled on the highway 4 with the availability of the power supply by the time zone.

In the present disclosure, when it is determined that the vehicle is traveling outside D-WPT section or outside D-WPT lane, it can be determined that the vehicle being traveled is not in a situation where the alignment of the primary coil on the ground side and the secondary coil on the vehicle side is required. Thus, sensors and beacons for alignment can be stopped, and wasteful power consumption can be suppressed.

According to an embodiment, when it is determined that the vehicle is traveling outside D-WPT section or outside D-WPT lane, it can be determined that the vehicle being traveled is not in a situation where the alignment of the primary coil on the ground side and the secondary coil on the vehicle side is required. Thus, sensors and beacons for alignment can be stopped, and wasteful power consumption can be suppressed.

According to an embodiment, when it is determined that the vehicle is traveling outside D-WPT section, it can be determined that the vehicle being traveled is not in a situation where the alignment of the primary coil on the ground side and the secondary coil on the vehicle side is required.

According to an embodiment, even when it is determined that the vehicle is traveling in D-WPT section, when it is determined that the vehicle is traveling outside D-WPT lane, it can be determined that the vehicle in traveling is not in a situation where the alignment of the primary coil on the ground side and the secondary coil on the vehicle side is required.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle control device, which is for controlling a vehicle having a secondary coil that receives non-contactly transmitted power from a primary coil installed on a road, wherein the vehicle control device is configured to, when determining that the vehicle is traveling outside a D-WPT section or the vehicle is traveling outside a D-WPT lane on a basis of position information of the vehicle, switch Fine Positioning from an on state to an off state.

2. The vehicle control device according to claim 1, wherein the vehicle control device is configured to:
determine whether the vehicle is traveling in the D-WPT section based on the position information of the vehicle,
maintain the Fine Positioning in the on state when determining that the vehicle is traveling in the D-WPT section, and
switch the Fine Positioning from the on state to the off state when determining that the vehicle is traveling outside the D-WPT section.

3. The vehicle control device according to claim 2, wherein the vehicle control device is configured to:
determine whether the vehicle is traveling in the D-WPT lane when determines that the vehicle is traveling in the D-WPT section,
maintain the Fine Positioning in the on state when determining that the vehicle is traveling in the D-WPT lane, and
switch the Fine Positioning from the on state to the off state when determining that the vehicle is traveling outside the D-WPT lane.
